(19) United States
(12) Patent Application Publication
(10) Pub. No.: US 2013/0319948 A1
(43) Pub. Date: Dec. 5, 2013

(54) REMEDIATION OF NAPHTHENIC ACID CONTAMINATION

(71) Applicant: Lignol Innovations Ltd., (US)

(72) Inventors: Alex BERLIN, Burnaby (CA); Oleksandr MYROSHNYCHENKO, Burnaby (CA)

(73) Assignee: Lignol Innovations Ltd., Burnaby (CA)

(21) Appl. No.: 13/849,385

(22) Filed: Mar. 22, 2013

Related U.S. Application Data
(63) Continuation of application No. PCT/CA2011/001083, filed on Sep. 26, 2011.
(60) Provisional application No. 61/386,458, filed on Sep. 24, 2010.

(51) Int. Cl. C02F 1/28

(52) U.S. Cl. CPC C02F 1/286
USPC 210/691; 210/690

(57) ABSTRACT

The present disclosure provides the use of a biomass-derived aromatic material as a sorbent for naphthenic acid. For example, the biomass-derived aromatic material may be a lignin derivative such as an Organsolv lignin derivative. The present disclosure further provides a method for reducing the amount of naphthenic acid in a substance, said method comprising applying a suitable amount of biomass-derived aromatic sorbent to the substance containing naphthenic acid; and allowing the sorbent to interact with the substance to remove at least a portion of the naphthenic acid from the substance.

This application is a continuation of PCT/CA2011/001083, filed Sep. 26, 2011; which claims the priority of U.S. Provisional Application No. 61/386,458, filed Sep. 24, 2010. The contents of the above-identified applications are incorporated herein by reference in their entireties.

### FIELD

This disclosure relates to naphthenic acids. This disclosure further relates to the use of lignins for environmental remediation such as, for example, remediation of naphthenic acid contamination. This disclosure further relates to the use of biomass-derived aromatic materials for the removal of naphthenic acids from a substance containing such acids.

### BACKGROUND

The term “naphthenic acids” is used, in general, for a non-specific mixture of organic acids in petroleum oil and its derivatives. Naphthenic acids often include several cyclopentyl and cyclohexyl carboxylic acids with molecular weights from 120 to 700 Da or more. Nevertheless, it is possible for naphthenic acids to comprise a variety of low-weight straight-chain acids or higher complex ones formed by multiples rings of 5 or 6 carbon atoms, saturated or unsaturated. The main fraction is carboxylic acids having a carbon backbone of from about 9 to about 20 carbon atoms.

Naphthenic acids occur naturally in crude oils from all over the world. Oil derivatives can also contain naphthenic acids. The percent in which they appear may vary according to their source. The Total Acid Number (TAN) is often used to indicate the amount of naphthenic acid present in oil. The TAN can be determined by titration of the sample against KOH, using either potentiometric (ASTM D664) or colorimetric (ASTM D974) analysis. Both methods allow the determination of the Strong Acid Number (SAN) and the TAN, both expressed in mg KOH.g-1 of sample. Carboxylic acids are detected in TAN, but not in SAN. For the majority of oils the SAN results are negligible, thus the TAN is generally used as a measure of naphthenic acidity. HPLC combined with MS detection, for instance LC/MS-QTOF, can be used to measure the concentration of NAs in solution (Isolation and characterization of naphthenic acids from Athabasca oil sands tailings pond water, Vincent V. Rogers, Karsten Liber, and Michael D. MacKinnon, Chemosphere, Volume 48, Issue 5, August 2002, pp. 519-527; Chi Lo Chun, Brian G. Brownlee, and Nigel J. Bunce, Mass spectrometric and toxicological assays of Athabasca oil sands naphthenic acids, Water Research, Volume 40, Issue 4, February 2006, pp. 655-664).

When naphthenic acids rich oil is processed in refineries, corrosion may occur which can lead to significant issues in refineries as well as loss of revenue. Therefore, attempts have been made to minimize the corrosion caused by such acids. Such efforts include selecting appropriate equipment materials, injecting corrosion inhibitors in the affected areas, and the removal of naphthenic acids by extraction or adsorption.

The most widely used and effective process for the removal of naphthenic acids from oils is the liquid-liquid extraction process, especially using ammonia or alkali alcoholic solutions. However, these systems usually form stable emulsions. Therefore, there are several proposals for the liquid-liquid extraction using different solvent systems. See, for example, Silva J. P. et al., Characterization of Commercial Ceramic Adsorbents and its Application on Naphthenic Acids Removal of Petroleum Distillates, Materials Research, Vol. 10, No. 2, 219-225, 2007.

In addition to being a problem in crude oil, naphthenic acids are a problem contaminant in the waste water resulting from extraction of bitumen from oil sands. Presently, about 12 barrels of water are required to produce 1 barrel of bitumen (Tariq Piracha, Natural Elements, NRCan's Monthly Newsletter, Squeezing Water form Oil Sands—Resources Management in Petroleum Development, Issue 22, February 2008; www.energy.alberta.ca/OurBusiness/oilsands). About 8 of the 12 barrels are recycled while about 4 barrels (636 L) are lost. Some companies operating in the Albertan oil sands claim they can recycle over 80% of the process water (www.suncor.com; www.syncrude.com).

Waste water from the extraction process is stored in a tailings pond and represents a major environmental challenge for the oil sands industry. The tailings pond may contain a mixture of water, clay, sand, residual bitumen, and other contaminants. The tailings are allowed to settle and the water recycled for use in the extraction process. Over time the amount of naphthenic acid contamination in the tailings increases and can present a serious risk to the environment. Currently there are no good solutions to the problem of naphthenic acid contamination in tailings ponds.

Various methods have been proposed for treating the effluent water from the oil sand extraction processes. See for example U.S. Pat. No. 3,487,003; U.S. Pat. No. 3,816,305; and Kasperski K L, A Review of Properties and Treatment of Oil Sands Tailings, AOSTRA Journal of Research, 8 (1992) 11.

There exists a need for a method for the effective and environmentally acceptable removal of naphthenic acids from water used in the production of bitumen from oil sands. In addition, there exists a need for an efficient way of reducing the TAN of crude oil or oil derivatives.

Recovered naphthenic acids might prove useful in a variety of manners such as, for example, use in deicing, dust control, wood preservation, and road stabilization; production of metallic naphthenates, synthetic detergents, solvents, lubricants, fuel additives, or corrosion inhibitors.

### SUMMARY

The present disclosure provides the use of biomass-derived aromatic materials, such as lignin derivatives, for reducing the amount of naphthenic acids in a substance. For example, the present use may be applied to waste water from a process for removing bitumen from oil-bearing sand to reduce the amount of naphthenic acids in a tailings pond. The present use may be applied to crude oil or oil derivatives to reduce the amount of naphthenic acids in such materials. The present disclosure provides the use of biomass-derived aromatic materials for reducing the amount of naphthenic acids and aromatic compounds in the waste water stream prior or after the removal of inorganic ions or other inorganic substances. This may be achieved by known technologies such as direct osmosis, reverse osmosis, electrodialysis, dialysis, thermo-ionic desalination, and the like.

As used herein, the term “biomass-derived aromatic materials” refers to an aromatic compound or compounds resulting from the processing of a lignocellulosic biomass. The term is intended to include mixtures of aromatic compounds with other non-aromatic compounds. For example, the biomass-derived aromatic material may be the result of an organosolv extraction of lignocellulosic biomass.

As used herein, the term “native lignin” refers to lignin in its natural state, in plant material.

As used herein, the terms “lignin derivatives” and “derivatives of native lignin” refer to lignin material extracted from lignocellulosic biomass. Usually, such material will be a mixture of chemical compounds that are generated during the extraction process.

As used herein, the term “sorbent” refers to materials that adsorb and/or absorb oil. Sorbents are generally inert and insoluble materials that remove contaminating oil through adsorption, in which the oil or hazardous substance is attracted to the sorbent surface and then adheres to it; absorption, in which the oil or hazardous substance penetrates the sorbent material; or a combination of the two.

This summary does not necessarily describe all features of the invention. Other aspects, features and advantages of the invention will be apparent to those of ordinary skill in the art upon review of the following description of specific embodiments of the invention.

### BRIEF DESCRIPTION OF THE DRAWINGS

FIG. 1 shows a typical Lignol® (Alcell®) organosolv process;

FIG. 2 shows a flow diagram of an embodiment of a process for extracting biomass-derived aromatic materials from a lignocellulosic feedstock;

FIG. 3 shows the absorption of naphthenic acids (NAs) in an aqueous solution by Lignol's® HP-L™ Lignin and a hardwood MAC-I. NAs Solution:Sorbent weight ratio 1000:1, room temperature, 150 rpm, 5 min, supernatant analyzed by LC/QTOF (1 ppm accuracy). A mix of naphthenic acids extracted from crude oil was purchased from SIGMA;

FIG. 4 shows the naphthenic acids content measured by LC/QTOF MS with a dynamic concentration range ˜4-40 ppm. LC/QTOF (MS Mode) of naphthenic acids (C(n)H(2n+z)O(x), Mw ˜200-700 Da);

FIG. 5 shows a flow diagram of an embodiment of a process for extracting biomass-derived aromatic materials from a lignocellulo sic feedstock where solvent preheating and flashing are part of the process;

FIG. 6 shows the absorption of naphthenic acids (NAs) in an aqueous solution by a range of aromatic renewable sorbents. NAs:Sorbent weight ratio 1000:1, room temperature, 150 rpm, 5 min, supernatant analyzed by LC/QTOF (1 ppm accuracy). A mix of naphthenic acids extracted from crude oil was purchased from SIGMA. The plot also shows the optical absorbance at 400 nm of the filtrates produced after treatment of NAs water solutions;

FIG. 7 shows the filtrates produced during the experiments described in the FIG. 6 reference;

FIG. 8 shows the visible spectra of the FIG. 7 filtrates and of distilled water;

FIG. 9 shows the UV spectra of the FIG. 7 filtrates (10 fold diluted) and of distilled water.

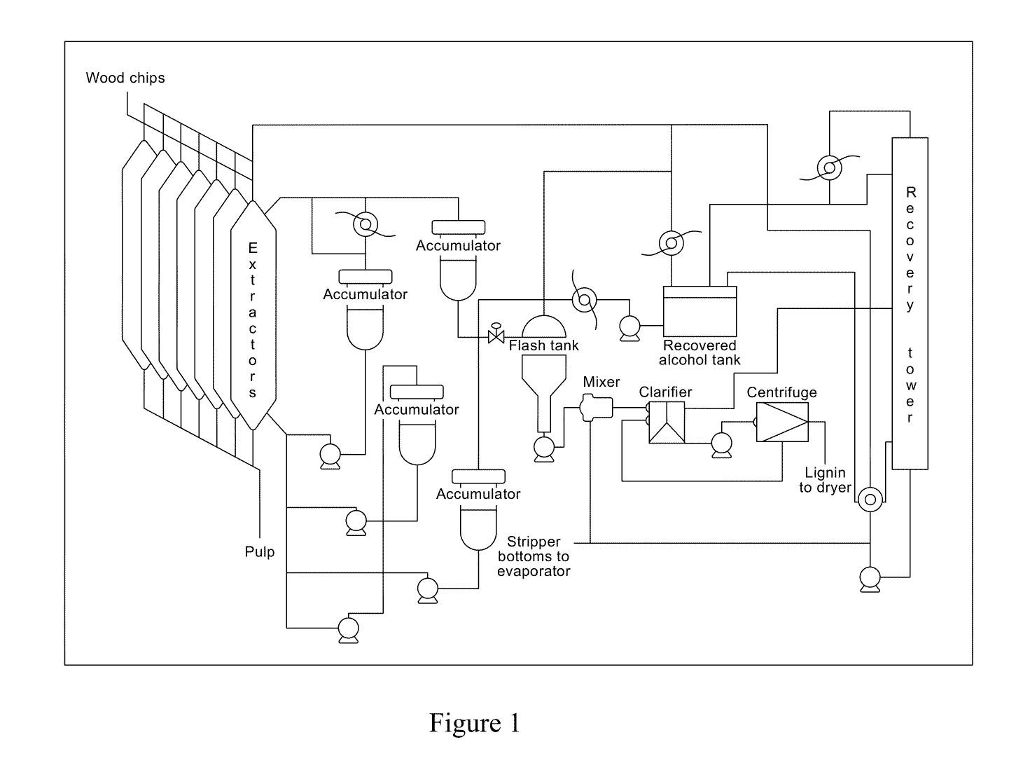

### DETAILED DESCRIPTION

The present disclosure provides the use of biomass-derived aromatic materials for reducing the amount of naphthenic acids in a substance. For example, the present use may comprise exposing the substance containing naphthenic acids to a derivative of native lignin. The present biomass-derived aromatic materials can be made from renewable resources which is advantageous from an environmental point of view. The present biomass-derived aromatic materials can be made from biodegradable materials which is also advantageous from an environmental point of view.

Surprisingly it has been found that certain biomass-derived aromatic materials are efficient sorbents of naphthenic acids. In certain embodiments the sorbents may also remove other contaminants such as other organic compounds, cations of heavy metals, inorganic anions, or other ions.

In certain embodiments of the present disclosure the biomass-derived aromatic material absorbs naphthenic acids from waste water at a solution to sorbent weight ratio of about 100:1 or greater, about 500:1 or greater, about 1000:1 or greater; about 1500:1 or greater, about 2000:1, about 5000:1 or greater.

In certain embodiments, it is preferred that the present sorbents float in the substance to be remediated. This allows the sorbents to be removed by skimming once they have absorbed the naphthenic acids. For example, when remediating water it is preferred that the sorbents have a density of less than 1 gcm⁻³ such as about 0.5 gcm⁻³.

In certain other embodiment, it is preferred that the sorbents do not float in the substance to be remediated. This allows the sorbents to accumulate at the bottom of the substance to be remediated. For example, in a reservoir the sorbent can sink to the bottom and be buried after recovering the water in the supernatant. The recovered water, free of NAs, and possibly some other organic and inorganic substances can be used for other purposes, such as, as a feed stream for a desalination system.

It is preferred that the sorbents be somewhat or even substantially insoluble in the substance to be remediated. For example, the sorbent may be substantially water-insoluble. In the case of applications for the remediation of oil-sands-related waste waters, the sorbents are preferably substantially insoluble in alkaline water solutions such as those with pH values about 8-9.

It is preferred that the sorbents do not discolor the substance.

It is preferred that the sorbents do not leach any organic or other substances.

It is preferred that the sorbents are not soluble in the substance to be remediated. For example, a tailings pond contain water with a pH of about 8.

It is preferred that the present sorbents have an absorption capacity of about 100 mg of naphthenic acid per gram or greater.

It is preferred that the sorbents have low levels of sodium, heavy metals, sulphur, halogenic compounds, or other potential contaminants.

Preferred sorbents for use herein have high molecular masses. For example, it is preferred that the weight average molecular weight be 100 Da or greater.

Any suitable biomass-derived aromatic material may be used herein. The biomass-derived aromatic materials are the result of processing lignocellulosic feedstock through an extraction process. Such materials include lignin derivatives as well as other process-derived bioaromatic materials (PBMs) which can be defined as ensembles of organic molecules, primarily aromatic in nature, which are derived from biomass (e.g. mixes of aromatic compounds (MACs). These materials can be used to replace more than one petrochemical in industrial chemical products and may also potentially be used to enhance the performance of the end-chemical products. Examples of PBMs include the products of condensation between furan derivatives and levulinic acid, phenol or phenol-like monomers or oligomers with ethanol, furan, and levulinates or formiates, and others.

The extraction process may comprise mixing an organic solvent with a lignocellulosic biomass under such conditions that a slurry is formed. As used herein, the term “slurry” refers to particles of biomass at least temporarily suspended in a solvent.

In one embodiment the present process comprises:
(a) placing a lignocellulosic material in an extraction vessel;
(b) mixing the lignocellulosic material with an organic solvent containing a catalyst to form an extraction mixture;
(c) subjecting the mixture to a temperature and pressure such that a slurry is formed;
(d) maintaining the elevated temperature and pressure for a period;
(e) recovering aromatic compounds from the solvent.

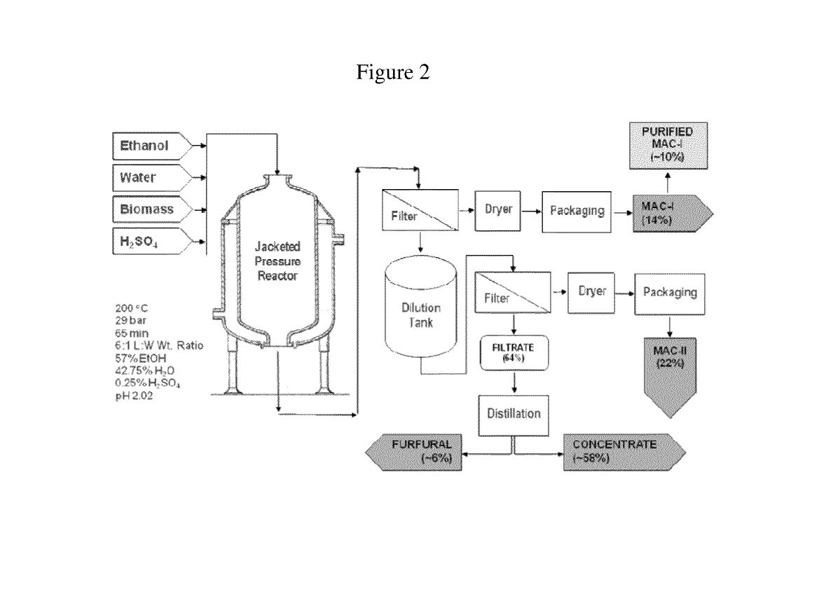

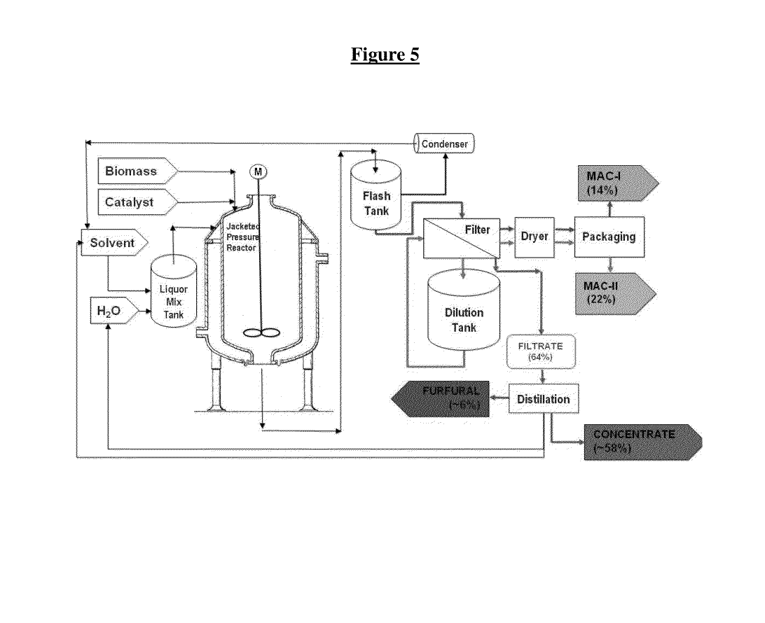

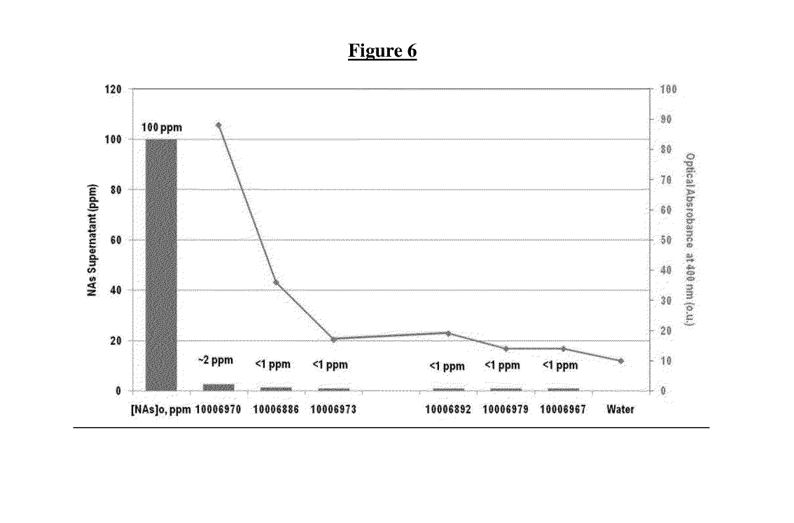

The extraction mixture slurry herein preferably has a viscosity of about 5000 cps or less, about 1500 cps or less, about 1000 cps or less, about 800 cps or less, about 600 cps or less, about 400 cps or less, about 200 cps or less, about 100 cps or less (viscosity measurements made using viscometer Viscolite 700 (Hydramotion Ltd., Malton, York Y017 6YA England). The extraction mixture preferably is subjected to pressures of about 1 bar or greater, about 5 bar or greater, about 10 bar or greater, about 15 bar or greater, about 18 bar or greater. For example, about 19 bar, about 20 bar, about 21 bar, about 22 bar, about 23 bar, about 24 bar, about 25 bar, about 26 bar, about 27 bar, about 28 bar, about 29 bar, or greater. The extraction mixture preferably is subjected to temperatures of from about 150° C. or greater, about 160° C. or greater, about 170° C. or greater, about 180° C. or greater, about 190° C. or greater, about 200° C. or greater, about 210° C. or greater. The extraction mixture preferably is subjected to the elevated temperature for about 5 minutes or more, about 10 minutes or more, about 15 minutes or more, about 20 minutes or more, about 25 minutes or more, about 30 minutes or more, about 35 minutes or more, about 40 minutes or more, about 45 minutes or more, about 50 minutes or more, about 55 minutes or more, about 60 minutes or more, about 65 minutes or more. The extraction mixture preferably is subjected to the elevated temperature for about 300 minutes or less, about 270 minutes or less, about 240 minutes or less, about 210 minutes or less, about 180 minutes or less, about 150 minutes or less, about 120 minutes or less. For example, the extraction mixture can be subjected to the elevated temperature for about 30 to about 100 minutes. The present extraction mixture preferably comprise about 40% or more, about 42% or more, about 44% or more, about 46% or more, about 48% or more, about 50% or more, about 52% or more, about 54% or more, organic solvent such as ethanol. The extraction mixture preferably comprises about 80% or less, about 70% or less, about 68% or less, about 66% or less, about 64% or less, about 62% or less, about 60% or less, organic solvent such as ethanol. For example, the extraction mixture may comprise about 45% to about 65%, about 50% to about 60% organic solvent such as ethanol. The extraction mixture preferably has a pH of about 1.0 or greater, about 1.2 or greater, about 1.4 or greater, about 1.6 or greater, about 1.8 or greater. The extraction mixture preferably has a pH of from about 3 or lower, about 2.8 or lower, about 2.6 or lower, about 2.4 or lower, about 2.2 or lower. For example, the extraction mixture may have a pH of from about 1.5 to about 2.5. For example, from about 1.6 to about 2.3. The weight ratio of solvent to biomass in the present extraction mixture may be from about 10:1 to about 2:1, about 9:1 to about 3:1, about 8:1 to about 4:1, from about 7:1 to about 5:1. For example the ratio may be about 6:1. The organic solvent may be selected from any suitable solvent. For example, aromatic alcohols such as phenol, catechol, and combinations thereof; short chain primary and secondary alcohols, such as methanol, ethanol, propanol, butanol, and combinations thereof. For example, the solvent may be a mix of ethanol & water. The solvent could be also be a mix of water miscible and water immiscible solvents such as ethanol and benzene, ethanol and toluene, etc. The immiscible with water solvent concentrates valuable products such as ethyl levulinate during the biomass extraction process and prevents by these means their water hydrolysis. The solvent mix might be preheated before being added to the extraction vessel. Examples of such an extraction process are given in FIG. 2 and FIG. 5. The liquid portion of the extraction mixture may be separated from the solid portion by any suitable means. For example, the slurry may be passed through an appropriately sized filter, centrifugation followed by decanting or pumping of the supernatant, tangential ultrafiltration, evaporation alone or solvent extraction followed by evaporation, among others. The aromatic compounds may be recovered from the liquid portion of the extraction mixture by any suitable means. For example, the solvent may be evaporated to precipitate the compounds. The compounds in the spent liquor can be recovered chromatographically followed by recrystallization or precipitation, dilution of the spent liquor with acidified water followed by filtration, centrifugation or tangential filtration, liquid/liquid extraction, among others. The aromatic compounds may be recovered in a single step or may be recovered in stages to provide compounds having different properties. The precipitated aromatic compounds do not seem to be sticky and are generally easy to filter. The compounds may be recovered for the extraction mixture by quenching the cooked mixture. For example, cold water may be added to the mixture in a ratio of 2 or more to 1 (H₂0 to extraction mixture). The compounds may be recovered by directly flashing the content of the extraction vessel to a scrubbing-paddle or a paddle dryer where the solvent could be recovered by a combination of condensing the flash vapours and the evaporated liquids. After the solvent recovery is completed the solids can be washed with water, the wash water drained and the solids be dried again without a need for transferring to another vessel. This technique may be useful when the aromatic compounds were sticky due, for instance, to biomass variability.

Lignin derivatives may be used herein. Any suitable lignin derivative may be used. Various lignin derivatives are known including purified softwood kraft lignins (e.g. Indulin AT®, MeadWestvaco, USA); kraft lignin purified by the Lignoboost process (Innventia, Sweden); purified hardwood kraft lignins (PC1369, MeadWestvaco, USA); kraft lignins; organosolv lignins (e.g. such as those available from Lignol® e.g. Alcell®, HP-L™); lignosulfonates or sulphite lignins (e.g. Reax85A®); soda lignins (e.g. soda lignins produced by Granit Recherche Développement SA, Switzerland); acid hydrolysis lignins produced by acid hydrolysis of wood and others (e.g. Polyphepane (Favorsky Irkutsk Institute of Chemistry SB RAS (Russia) or by the Concentrated Hydrochloric Acid Process, pilot plant CHEMATUR, ENGINEERING AB, Sweden); “Pure Lignin” produced by Pure Lignin Environmental Technology (Kelowna, BC); Curan 27-11P; Sarkandaand; and combinations thereof.

Any suitable lignocellulosic biomass may be utilized herein including hardwoods, softwoods, annual fibres, energy crops, municipal waste, and combinations thereof.

Hardwood feedstocks include Acacia; Afzelia; Synsepalum duloificum; Albizia; Alder (e.g. Alnus glutinosa, Alnus rubra); Applewood; Arbutus; Ash (e.g. F. nigra, F. quadrangulata, F. excelsior, F. pennsylvanica lanceolata, F. latifolia, F. profunda, F. americana); Aspen (e.g. P. grandidentata, P. tremula, P. tremuloides); Australian Red Cedar (Toona ciliata); Ayna (Distemonanthus benthamianus); Balsa (Ochroma pyramidale); Basswood (e.g. T. americana, T. heterophylla); Beech (e.g. F. sylvatica, F. grandifolia); Birch; (e.g. Betula populifolia, B. nigra, B. papyrifera, B. lenta, B. alleghaniensis/B. lutea, B. pendula, B. pubescens); Blackbean; Blackwood; Bocote; Boxelder; Boxwood; Brazilwood; Bubing a; Buckeye (e.g. Aesculus hippocastanum, Aesculus glabra, Aesculus flava/Aesculus octandra); Butternut; Catalpa; Cherry (e.g. Prunus serotina, Prunus pennsylvanica, Prunus avium); Crabwood; Chestnut; Coachwood; Cocobolo; Corkwood; Cottonwood (e.g. Populus balsamifera, Populus deltoides, Populus sargentii, Populus heterophylla); Cucumbertree; Dogwood (e.g. Cornus florida, Cornus nuttallii); Ebony (e.g. Diospyros kurzii, Diospyros melanida, Diospyros crassiflora); Elm (e.g. Ulmus americana, Ulmus procera, Ulmus thomasii, Ulmus rubra, Ulmus glabra); Eucalyptus; Greenheart; Grenadilla; Gum (e.g. Nyssa sylvatica, Eucalyptus globulus, Liquidambar styraciflua, Nyssa aquatica); Hickory (e.g. Carya alba, Carya glabra, Carya ovata, Carya laciniosa); Hornbeam; Hophornbeam; Ipê; Iroko; Ironwood (e.g. Bangkirai, Carpinus caroliniana, Casuarina equisetifolia, Choricbangarpia subargentea, Copaifera spp., Eusideroxylon zwageri, Guajacum officinale, Guajacum sanctum, Hopea odorata, Ipe, Krugiodendron ferreum, Lyonothamnus lyonii (L. floribundus), Mesua ferrea, Olea spp., Olneya tesota, Ostrya virginiana, Parrotia persica, Tabebuia serratifolia); Jacarandá; Jotoba; Lacewood; Laurel; Limba; Lignum vitae; Locust (e.g. Robinia pseudacacia, Gleditsia triacanthos); Mahogany; Maple (e.g. Acer saccharum, Acer nigrum, Acer negundo, Acer rubrum, Acer saccharinum, Acer pseudoplatanus); Meranti; Mpingo; Oak (e.g. Quercus macrocarpa, Quercus alba, Quercus stellata, Quercus bicolor, Quercus virginiana, Quercus michauxii, Quercus prinus, Quercus muhlenbergii, Quercus chrysolepis, Quercus lyrata, Quercus robur, Quercus petraea, Quercus rubra, Quercus velutina, Quercus laurifolia, Quercus falcata, Quercus nigra, Quercus phellos, Quercus texana); Obeche; Okoumé; Oregon Myrtle; California Bay Laurel; Pear; Poplar (e.g. P. balsamifera, P. nigra, Hybrid Poplar (Populus x canadensis)); Ramin; Red cedar; Rosewood; Sal; Sandalwood; Sassafras; Satinwood; Silky Oak; Silver Wattle; Snakewood; Sourwood; Spanish cedar; American sycamore; Teak; Walnut (e.g. Juglans nigra, Juglans regia); Willow (e.g. Salix nigra, Salix alba); Yellow poplar (Liriodendron tulipifera); Bamboo; Palmwood; and combinations/hybrids thereof.

For example, hardwood feedstocks for the present invention may be selected from Acacia, Aspen, Beech, Eucalyptus, Maple, Birch, Gum, Oak, Poplar, and combinations/hybrids thereof. The hardwood feedstocks for the present invention may be selected from Populus spp. (e.g. Populus tremuloides), Eucalyptus spp. (e.g. Eucalyptus globulus), Acacia spp. (e.g. Acacia dealbata), and combinations/hybrids thereof.

Softwood feedstocks include Araucaria (e.g. A. cunninghamii, A. angustifolia, A. araucana); softwood Cedar (e.g. Juniperus virginiana, Thuja plicata, Thuja occidentalis, Chamaecyparis thyoides Callitropsis nootkatensis); Cypress (e.g. Chamaecyparis, Cupressus Taxodium, Cupressus arizonica, Taxodium distichum, Chamaecyparis obtusa, Chamaecyparis lawsoniana, Cupressus semperviren); Rocky Mountain Douglas fir; European Yew; Fir (e.g. Abies balsamea, Abies alba, Abies procera, Abies amabilis); Hemlock (e.g. Tsuga canadensis, Tsuga mertensiana, Tsuga heterophylla); Kauri; Kaya; Larch (e.g. Larix decidua, Larix kaempferi, Larix laricina, Larix occidentalis); Pine (e.g. Pinus nigra, Pinus banksiana, Pinus contorta, Pinus radiata, Pinus ponderosa, Pinus resinosa, Pinus sylvestris, Pinus strobus, Pinus monticola, Pinus lambertiana, Pinus taeda, Pinus palustris, Pinus rigida, Pinus echinata); Redwood; Rimu; Spruce (e.g. Picea abies, Picea mariana, Picea rubens, Picea sitchensis, Picea glauca); Sugi; and combinations/hybrids thereof.

For example, softwood feedstocks which may be used herein include cedar; fir; pine; spruce; and combinations/hybrids thereof. The softwood feedstocks for the present invention may be selected from loblolly pine (Pinus taeda), radiata pine, jack pine, spruce (e.g., white, interior, black), Douglas fir, Pinus silvestris, Picea abies, and combinations/hybrids thereof. The softwood feedstocks for the present invention may be selected from pine (e.g. Pinus radiata, Pinus taeda); spruce; and combinations/hybrids thereof.

Annual fibre feedstocks include biomass derived from annual plants, plants which complete their growth in one growing season and therefore must be planted yearly. Examples of annual fibres include: flax, cereal straw (wheat, barley, oats), sugarcane bagasse, rice straw, corn stover, corn cobs, hemp, fruit pulp, alfalfa grass, esparto grass, switchgrass, and combinations/hybrids thereof. Industrial residues like corn cobs, fruit peals, seeds, etc. may also be considered annual fibres since they are commonly derived from annual fibre biomass such as edible crops and fruits. For example, the annual fibre feedstock may be selected from wheat straw, corn stover, corn cobs, sugar cane bagasse, and combinations/hybrids thereof.

The present disclosure provides biomass-derived aromatic materials sorbents for naphthenic acids. Any substance comprising naphthenic acids may be addressed such as, for example, crude oil; petroleum products, effluent streams from oil extraction processes (e.g. bitumen extraction), and the like.

One class of suitable biomass-derived aromatic materials are lignin derivatives. The present lignin derivatives may comprise alkoxy groups. For example, the present lignin derivatives may have an alkoxy content of 2 mmol/g or less; about 1.4 mmol/g or less; about 1.2 mmol/g or less; about 1 mmol/g or less; about 0.8 mmol/g or less; about 0.7 mmol/g or less; about 0.6 mmol/g or less; about 0.5 mmol/g or less; about 0.4 mmol/g or less; about 0.3 mmol/g or less. The present lignin derivatives may have an alkoxy content of 0.001 mmol/g or greater, about 0.01 mmol/g of greater, about 0.05 mmol/g or greater, about 0.1 mmol/g or greater.

The present lignin derivatives may comprise ethoxyl groups. For example, the present lignin derivatives may have an ethoxyl content of 2 mmol/g or less; about 1.4 mmol/g or less; about 1.2 mmol/g or less; about 1 mmol/g or less; about 0.8 mmol/g or less; about 0.7 mmol/g or less; about 0.6 mmol/g or less; about 0.5 mmol/g or less; about 0.4 mmol/g or less; about 0.3 mmol/g or less. The present lignin derivatives may have an ethoxyl content of 0.001 mmol/g or greater, about 0.01 mmol/g of greater, about 0.05 mmol/g or greater, about 0.1 mmol/g or greater.

The present lignin derivatives may have any suitable phenolic hydroxyl content such as from about 2 mmol/g to about 8 mmol/g. For example, the phenolic hydroxyl content may be from about 2.5 mmol/g to about 7 mmol/g; about 3 mmol/g to about 6 mmol/g.

The present lignin derivatives preferably have a total hydroxyl content of about 0.1 mmol/g to about 15 mmol/g. For example, the present lignin derivatives may have a total hydroxyl content of from about 1 mmol/g, about 2 mmol/g, 3.5 mmol/g, 4 mmol/g, 4.5 mmol/g, or greater. The present lignin derivatives may have a total hydroxyl content of from about 13 mmol/g, about 11 mmol/g, about 10 mmol/g, about 9 mmol/g, or less.

As used herein the term “total hydroxyl content” refers to the quantity of hydroxyl groups in the lignin derivatives and is the arithmetic sum of the quantity of aliphatic and phenolic hydroxyl groups (OHtot=OHal+OHph). OHal is the arithmetic sum of the quantity of primary and secondary hydroxyl groups (OHal=OHpr+OHsec). The hydroxyl content can be measured by quantitative high resolution ¹³C NMR spectroscopy of acetylated lignin derivatives, using, for instance, 1,3,5-trioxane and tetramethyl silane (TMS) as internal reference. For the data analysis “BASEOPT” (DIGMOD set to baseopt) routine in the software package TopSpin 2.1.4 was used to predict the first FID data point back at the mid-point of ¹³C r.f. pulse in the digitally filtered data was used. For the NMR spectra recording a Bruker AVANCE II digital NMR spectrometer running TopSpin 2.1 was used. The spectrometer used a Bruker 54 mm bore Ultrashield magnet operating at 14.1 Tesla (600.13 MHz for ¹H, 150.90 MHz for ¹³C). The spectrometer was coupled with a Bruker QNP cryoprobe (5 mm NMR samples, ¹³C direct observe on inner coil, ¹H outer coil) that had both coils cooled by helium gas to 20K and all preamplifiers cooled to 77K for maximum sensitivity. Sample temperature was maintained at 300K±0.1K using a Bruker BVT 3000 temperature unit and a Bruker BCU05 cooler with ca. 95% nitrogen gas flowing over the sample tube at a rate of 800 L/h.

Quantification of ethoxyl groups was performed similarly to aliphatic hydroxyls quantification by high resolution ¹³C NMR spectroscopy. Identification of ethoxyl groups was confirmed by 2D NMR HSQC spectroscopy. 2D NMR spectra were recorded by a Bruker 700 MHz UltraShield Plus standard bore magnet spectrometer equipped with a sensitive cryogenically cooled 5 mm TCI gradient probe with inverse geometry. The acquisition parameters were as follow: standard Bruker pulse program hsqcetgp, temperature of 298K, a 90° pulse, 1.1 sec pulse delay (dl), and acquisition time of 60 msec.

The present lignin derivatives may have any suitable number average molecular weight (Mn). For example, the Mn may be from about 200 g/mol to about 10000 g/mol; about 350 g/mol to about 3000 g/mol; about 500 g/mol to about 2000 g/mol.

The present lignin derivatives may have any suitable weight average molecular weight (Mw). For example, the Mw may be from about 500 g/mol to about 10000 g/mol; about 750 g/mol to about 4000 g/mol; about 900 g/mol to about 3500 g/mol.

The present lignin derivatives are preferably hydrophobic. Hydrophobicity may be assessed using standard contact angle measurements. In the case of lignin a pellet may be formed using a FTIR KBr pellet press. Then a water droplet is added onto the pellet surface and the contact angle between the water droplet and the lignin pellet is measured using a contact angle goniometer. As the hydrophobicity of lignins increases the contact angle also increases. Preferably the lignins herein will have a contact angle of about 90° or greater.

The present disclosure provides a method for reducing the amount of naphthenic acids in a substance, said method comprising:
a. Applying a suitable amount of biomass-derived aromatic sorbent, such as a lignin derivative, to the substance containing naphthenic acids;
b. Allowing the sorbent to interact with the substance, for example, by mixing to create a naphthenic acid-rich sorbent; and optionally
c. Removing at least a portion of the acid-rich sorbent material.

The present disclosure provides a method for reducing the amount of naphthenic acid in water, said method comprising:
a. Applying a suitable amount of biomass-derived aromatic sorbent, such as a lignin derivative, to the water containing naphthenic acids;
b. Allowing the sorbent to interact with the substance, for example, by mixing to create a naphthenic acid-rich sorbent; and optionally
c. Removing at least a portion of the rich sorbent material.

The present disclosure provides a method for reducing the amount of naphthenic acid in tailing pond water, said method comprising:
a. Applying a suitable amount of biomass-derived aromatic sorbent, such as a lignin derivative, to the tailing pond water containing naphthenic acids;
b. Allowing the sorbent to interact with the substance, for example, by mixing to create a naphthenic acid-rich sorbent; and optionally
c. Removing at least a portion of the rich sorbent material.

The present disclosure provides a method for reducing the amount of naphthenic acid in oil, said method comprising:
a. Applying a suitable amount of biomass-derived aromatic sorbent, such as a lignin derivative, to the oil containing naphthenic acids;
b. Allowing the sorbent to interact with the substance, for example, by mixing to create a naphthenic acid-rich sorbent; and optionally
c. Removing at least a portion of the rich sorbent material.

The present disclosure provides a method for reducing the amount of naphthenic acid in crude oil, said method comprising:
a. Applying a suitable amount of biomass-derived aromatic sorbent, such as a lignin derivative, to the oil containing naphthenic acids;
b. Allowing the sorbent to interact with the substance, for example, by mixing to create a naphthenic acid-rich sorbent; and optionally
c. Removing at least a portion of the rich sorbent material.

The sorbent may be applied in any suitable form. For example, the sorbent may be in particulate form such as a powder, pellet, granule, or the like. The sorbent may be applied as a liquid in a suitable solvent. The sorbent may be applied as strands, sheets, rolls, pillows, booms, or the like.

The sorbent may be applied in any suitable manner. For example, the sorbent may be sprayed, spread by hand or other mechanical means, or may be maintained in a support and the substance to be remediated flowed over it.

The naphthenic acid-rich sorbent may be removed in any suitable manner. For example, the material may be skimmed, dredged, vacuumed, filtered, combusted, or it may be left in-situ in the environment, or safely disposed of especially in case where the sorbent material is biodegradable.

Once recovered the sorbent may be disposed of in any suitable manner. For example, by combustion, bioremediation, safe storage, chemical processing, or the like. In an embodiment of the present disclosure the naphthenic acid-rich sorbent is combusted. An advantage of using a biomass-derived aromatic sorbent is that they are produced or derived from a renewable resource which aids in maintaining carbon neutrality.

It is contemplated that any embodiment discussed in this specification can be implemented or combined with respect to any other embodiment, method, composition or aspect of the invention, and vice versa.

Unless defined otherwise, all technical and scientific terms used herein have the same meaning as is commonly understood by one of ordinary skill in the art to which this invention belongs. Unless otherwise specified, all patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference. Citation of references herein is not to be construed nor considered as an admission that such references are prior art to the present invention.

Use of examples in the specification, including examples of terms, is for illustrative purposes only and is not intended to limit the scope and meaning of the embodiments of the invention herein. Numeric ranges are inclusive of the numbers defining the range. In the specification, the word “comprising” is used as an open-ended term, substantially equivalent to the phrase “including, but not limited to,” and the word “comprises” has a corresponding meaning.

The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way.

The present invention will be further illustrated in the following examples. However it is to be understood that these examples are for illustrative purposes only, and should not be used to limit the scope of the present invention in any manner.

### EXAMPLES

### Example 1

A naphthenic acids (NAs) mix extracted from crude oil was purchased from Sigma-Aldrich (Cat. #70340, CAS Number: 1338-24-5). A 10,000 ppm stock solution of NAs was prepared in distilled water. The stock solution was further diluted with distilled water to obtain 100 ppm NAs final concentration. The 100 ppm NAs solution was incubated at room temperature for 5 minutes with Lignol's sorbent #10006892 at sorbent:solution weight ratio of 1:1000. The solution-solvent mix (0.50 g sorbent and 500 g NAs solution) was agitated at 150 rpm. After agitation the solids and liquid were separated by filtration on paper filter Whatman N° 2. The liquid filtrate was then analyzed by LC/QTOF for NAs and compared to the untreated 100 ppm standard. The LC/QTOF NAs analysis was performed in accordance with the methodology described in Isolation and characterization of naphthenic acids from Athabasca oil sands tailings pond water, Vincent V. Rogers, Karsten Liber, and Michael D. MacKinnon, Chemosphere, Volume 48, Issue 5, August 2002, pp. 519-527. The concentration of NAs in solution was reduced to ≦1 ppm as a result of the sorbent treatment. The experiment was run in triplicate with similar results for all three independent experiments. Control experiments were run to confirm that NAs do not bind to the filter paper Whatman N° 2.

### Example 2

A naphthenic acids (NAs) mix extracted from crude oil was purchased from Sigma-Aldrich (Cat. #70340, CAS Number: 1338-24-5). A 10,000 ppm stock solution of NAs was prepared in distilled water. The stock solution was further diluted with distilled water to obtain 50 ppm final concentration. The 50 ppm NAs solution was incubated at room temperature for 5 minutes with Lignol's sorbent #10006892 at sorbent:solution weight ratio of 1:1000. The solution-solvent mix (0.50 g sorbent and 500 g NAs solution) was agitated at 150 rpm. After agitation the solids and liquid were separated by filtration on paper filter Whatman N° 2. The liquid filtrate is then analyzed by LC/QTOF for NAs and compared to the untreated 100 ppm standard. The concentration of NAs in solution was reduced to ≦1 ppm as a result of the sorbent treatment. The experiment was run in triplicate with similar results for all three independent experiments. Control experiments were run to confirm that NAs do not bind to the filter paper Whatman N° 2.

### Example 3

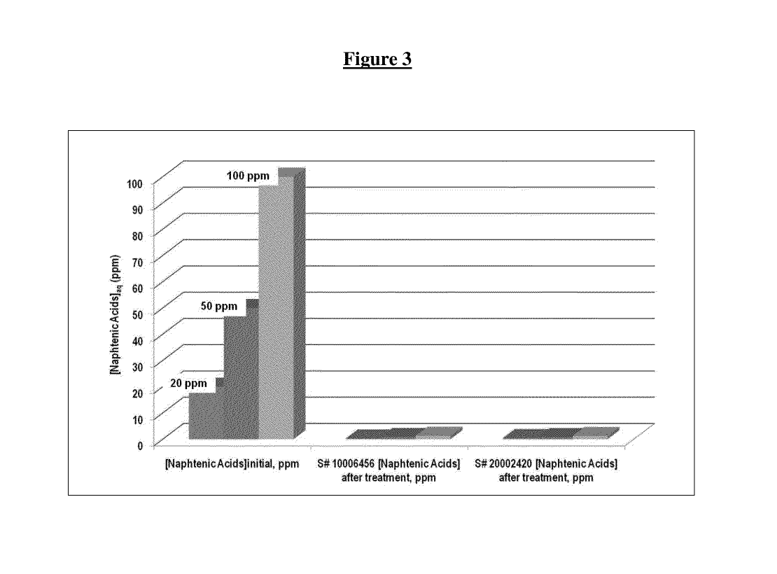

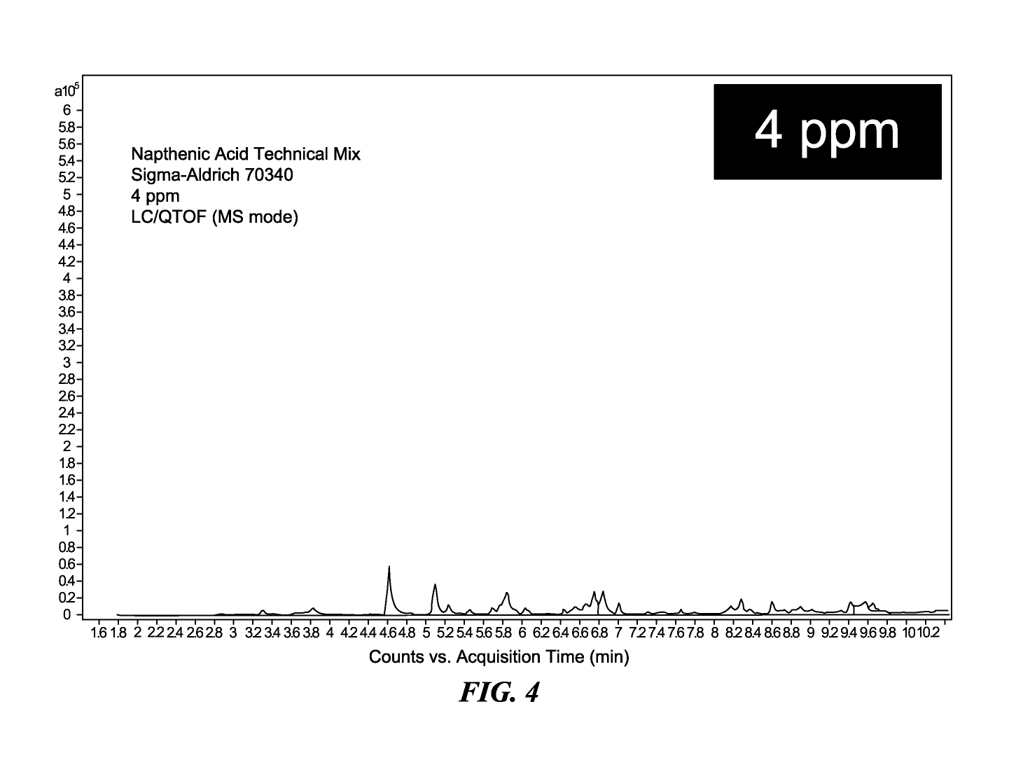

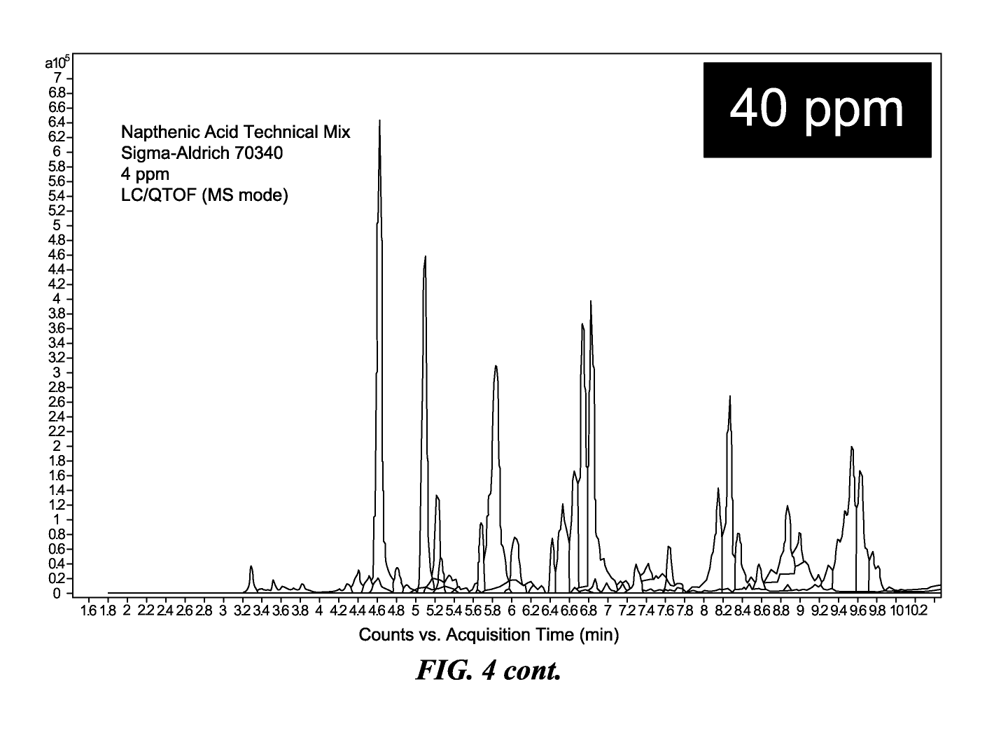

Identical experiments to examples 2 & 1 were conducted for all the sorbents listed below with similar results (FIGS. 3 & 6):

### 10006970—Granit R&D S.A. Lignin

### 10006886—Unwashed MAC-II

### 10006973—Indulin AT (Meadwestvaco, USA)

10006979—Russian hydrolysis lignin
10006967—Polyphepanum (purified commercial Russian hydrolysis lignin)

### 20002420—PP165 HP-L™ Lignin

### 10006456—Unwashed MAC-I

### Example 4

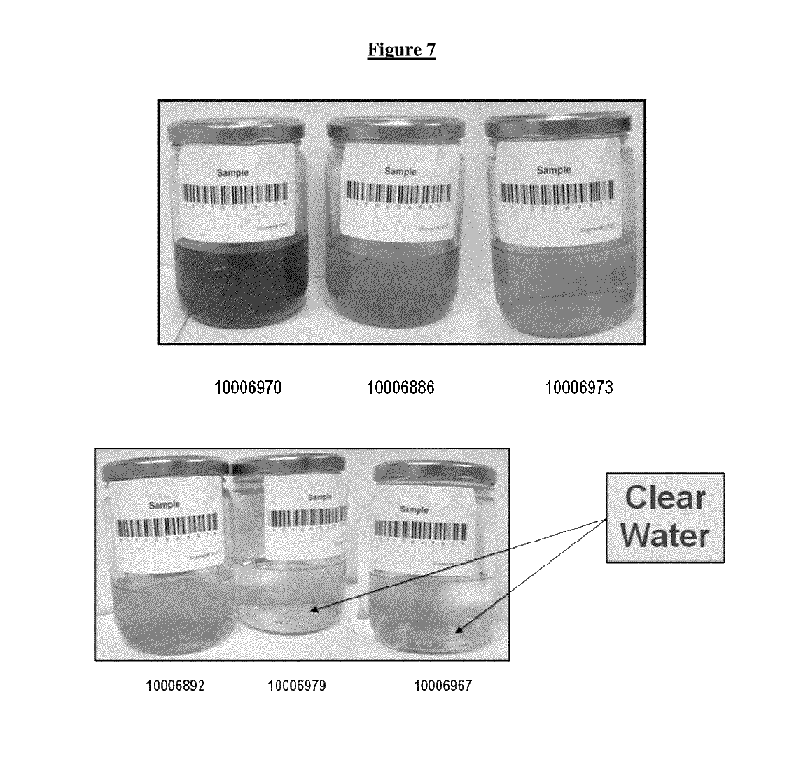

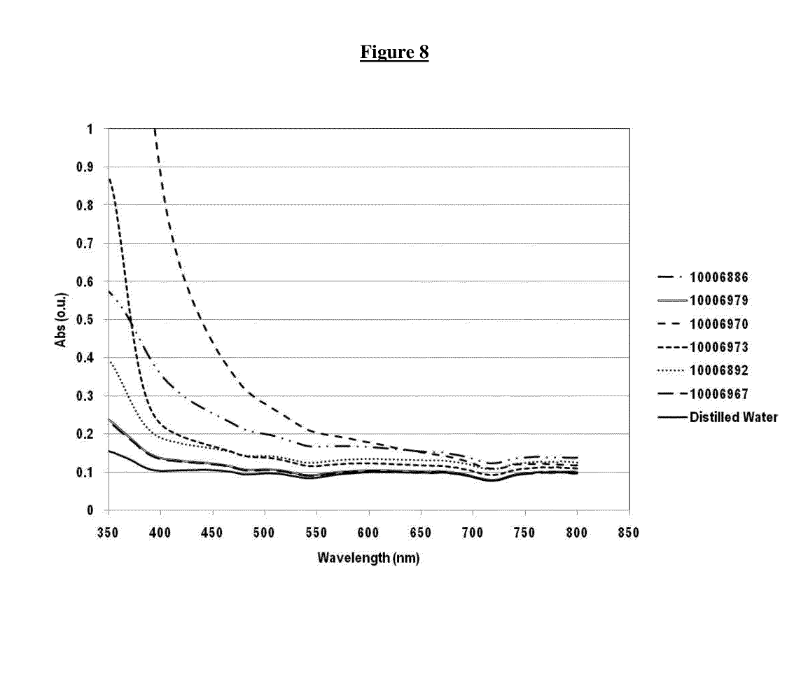

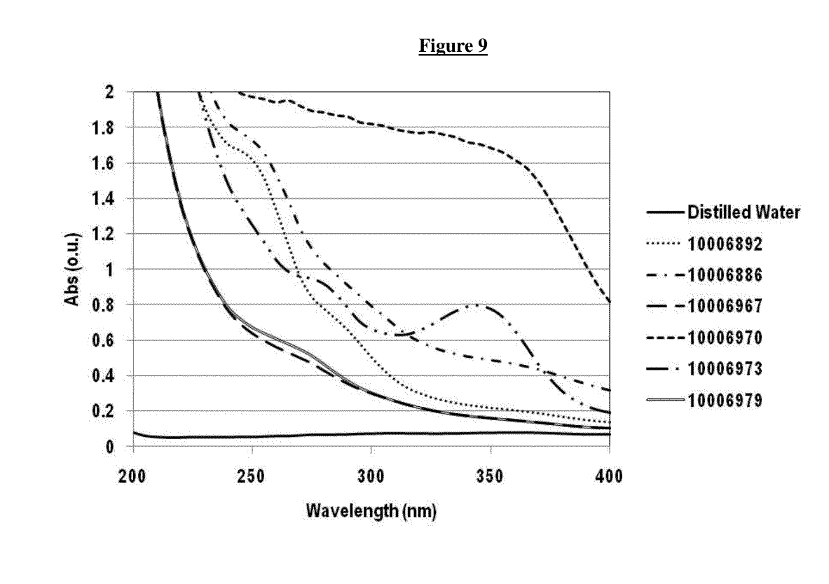

All filtrates produced during the previous experiments (Examples 1-3) were analyzed spectrophotometrically with a spectrophotometer Cary50 Bio (Varian, Inc., Santa Clara, Calif., USA) in the visible and UV regions (FIGS. 8-9) without diluting the samples. Surprisingly it was found that sorbents 10006979 and 10006967 produced completely clear solutions after NAs removal treatment (FIG. 7) which was confirmed spectrophotometrically in the visible region (FIG. 8). The optical absorbance of these two filtrates was very low in the visible spectral region and close to the absorbance of distilled water. Filtrates from the 10006979 and 10006967 experiments showed also the lowest optical absorbance in the near UV region.

### Example 5

A water sample from an Albertan tailings pond (pH ˜8.5) containing about 10 ppm NAs was treated with the sorbent #10006892 in a similar way to the experiments described in 1-3. LC/QTOF analysis showed a reduction of the NAs in solution of over 70%.

1. Use of a biomass-derived aromatic material as a sorbent for naphthenic acid.

2. The use according to claim 1, wherein the biomass-derived aromatic material is a lignin derivative.

3. The use according to claim 1, wherein the biomass-derived aromatic material is an organosolv lignin derivative.

4. The use according to claim 1, wherein the sorbent has a density of less than 1 gcm⁻³.

5. The use according to claim 1, wherein the sorbent has an absorption capacity of about 100 mg of naphthenic acid per gram or greater.

6. A method for reducing the amount of naphthenic acid in a substance, said method comprising applying a suitable amount of biomass-derived aromatic sorbent to the substance containing naphthenic acid; and allowing the sorbent to interact with the substance to remove at least a portion of the naphthenic acid from said substance.

7. The method according to claim 6, wherein the method comprises a further step of removing at least a portion of naphthenic acid-rich sorbent material.

8. The method according to claim 6, wherein the biomass-derived aromatic material is a lignin derivative.

9. The method according to claim 6, wherein the biomass-derived aromatic material is an organosolv lignin derivative.

10. The method according to claim 6, wherein the sorbent has a density of less than 1 gcm⁻³.

11. The method according to claim 6, wherein the sorbent has an absorption capacity of about 100 mg of naphthenic acid per gram or greater.

12. The method according to claim 6, wherein the substance containing naphthenic acid is crude oil.

13. The method according to claim 6, wherein the substance containing naphthenic acid is water.

14. The method according to claim 6, wherein the substance containing naphthenic acid is waste water from a bitumen extraction process.

15. The method according to claim 6, wherein the substance containing naphthenic acid is water from a tailings pond.
